(19) United States
(12) Patent Application Publication
(10) Pub. No.: US 2010/0321395 A1
(43) Pub. Date: Dec. 23, 2010

(54) DISPLAY SIMULATION SYSTEM AND METHOD

(75) Inventors: Maciej Maciesowicz, Gilroy, CA (US); Carol Lavelle, Saratoga, CA (US); David A. Curran, Newark, CA (US); Jiming Sun, Cupertino, CA (US)

Correspondence Address: APPLE INC.;c/o Fletcher Yoder, PC, P.O. Box 692289, Houston, TX, 77269-2289, US

(73) Assignee: APPLE INC., Cupertino, CA (US)

(21) Appl. No.: 12/486,940

(22) Filed: Jun. 18, 2009

(51) Int. Cl. G06T 1/00; G06F 15/16; G09G 5/36

(52) U.S. Cl. 345/502; 345/545; 345/522

(57) ABSTRACT

A display simulation system is provided having a flexible design for emulating and/or supporting any number of display types and/or display standards. The display simulation system may include one or more reference drivers that include a virtual graphics processing unit (GPU) and one or more virtual frame buffer drivers. In one embodiment, the display simulation system may implement a virtual display in response to a user selection input. For instance, the user selection input may initiate a simulated hot-plug event on the display simulation system. Based upon the user selection, an appropriate display profile corresponding to the selected display type or standard may be loaded by the display driver. In this manner, the display simulation system may provide for user interaction with the virtual display, such as for testing, verification, benchmarking, or development purposes.

### BACKGROUND

The present disclosure relates generally to display devices and, more specifically, to techniques for simulating display devices on a computing device.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

As display technologies continue to advance, newer display standards are constantly being developed. However, due to the nature of the development cycle, the development and testing of software infrastructures for new display standards generally lags with respect to the hardware development. This is due at least partially to the fact that software development of drivers and related applications for a particular display standard is largely dependent on having a hardware platform available to perform proper testing, debug, verification, benchmarking, and so forth, of the software infrastructure.

Further, due to the offset in the hardware and software development cycles, substantial progress in the development of software for a new display standard may, in some instances, occur only after the display hardware itself has been implemented. As such, software developers are given relatively little time to develop a fully functional software package for the new display standard before the hardware is introduced to the market. Additionally, even if software developers are able to provide a full software package that coincides with the introduction of a new display standard to the market, there may not have been sufficient time to fully test, debug, and/or verify the software and hardware infrastructures for the new display standard.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure generally relates to techniques for simulating displays in a computing system. In one embodiment, a display simulator application is provided having a flexible design for emulating and/or supporting any number of display types and/or display standards. The display simulator application may be configured to execute on a variety of platforms, and may provide one or more generic virtual display ports and reference frame buffer drivers. Depending on a display profile selected and/or provided by a user, a virtual display may be implemented by configuring the reference frame buffer driver (which may include a virtual graphics processing unit, a virtual frame buffer driver, and a virtual frame buffer), in accordance with the selected display profile. The reference frame buffer provides an abstraction layer, such that from the view point of an operating system, the virtual display appears as a physical display on the computing system. The display simulation system may, therefore, allow a user to interact with the virtual display, thus facilitating software testing, verification, benchmarking, and/or development.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a simplified block diagram depicting components of an example of an electronic device that includes a display simulator application, in accordance with an embodiment of the present technique;

FIG. 2 is a view of an electronic computing device that may store and execute a display simulator application, in accordance with an embodiment of the present technique;

FIG. 3 is a simplified block diagram of a display simulator application, in accordance with an embodiment of the present technique;

FIG. 4 is a system diagram of an embodiment of a software stack that includes the display simulator application, in accordance with an embodiment of the present technique;

FIG. 5 is a flowchart depicting steps for simulating a display device on a computing system using the display simulator application, in accordance with an embodiment of the present technique;

FIGS. 6 and 7 are block diagrams depicting the simulation of display devices on a system bus, in accordance with an embodiment of the present technique;

FIG. 8 is a system diagram showing display simulation results from FIGS. 6 and 7, in accordance with an embodiment of the present technique;

FIG. 9 is a graphical representation of a physical display and one or more virtual displays, in accordance with an embodiment of the present technique;

FIG. 10 shows an embodiment of the electronic device of FIG. 1 being configured to display the output of the virtual displays of FIG. 9 in a manner that is viewable by a user, in accordance with an embodiment of the present technique;

FIG. 11 is a block diagram showing the simulation of a plurality of simulated display devices arranged in a series connection (“daisy-chained”) on a system bus, in accordance with an embodiment of the present technique; and

FIG. 12 is a system diagram showing display simulation results from FIG. 11, in accordance with an embodiment of the present technique.

### DETAILED DESCRIPTION OF SPECIFIC EMBODIMENTS

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As will be discussed below, the present disclosure generally provides techniques for simulating one or more display devices on a computing system. In particular, a display simulation system, in accordance with the embodiments discussed below, may provide software developers a tool to implement, test, and verify new software infrastructures for new and emerging display technologies at least partially in parallel with the hardware development cycle. In one embodiment, a display simulator application is provided. The display simulator application may include a user-side control application, and a kernel-side client module, and may further provide for a plurality of virtual display interface ports, each corresponding to a reference frame buffer driver. Based on user inputs received via the control application, a display profile may be selected and transmitted to the client module. By way of example, the display profile may include Extended Display Identification Data (EDID), supported resolutions, timings, refresh rates, and so forth. In one embodiment, a user selection of a display profile may initiate a simulated hot-plug event on the computing system, in which the operating system retrieves display device data based on the selected display profile. Using the display profile, a virtual display device may be created on the computing system by configuring an appropriate virtual display interface port and reference frame buffer. In this manner, a display simulation system, in accordance with embodiments of the present technique, may provide for user interaction with the virtual display, such as for testing, verification, benchmarking, and/or development purposes.

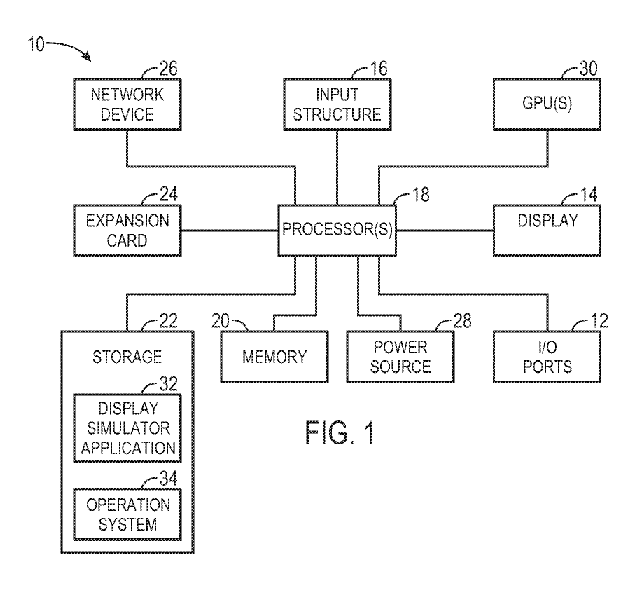

For the purposes of the present disclosure, the terms “virtual display,” “simulated display,” “emulated display” or the like shall be understood to mean a non-physical display device that is created or generated using the display simulation techniques discussed herein. Additionally, where the terms “connecting,” or “connect,” or the like are used to describe the simulated connection of a simulated display device to a virtual display port interface, it should be understood that the connection is meant to be a virtual connection between simulated display devices and virtual display ports, rather than being a physical connection between physical hardware components. The foregoing features, aspects, and other advantages of the techniques disclosed herein will be discussed in further detail below with reference to FIGS. 1-12.

Referring initially to FIG. 1, a block diagram showing an example of an electronic device 10 that may be configured to implement the display simulation techniques disclosed herein is illustrated, in accordance with an embodiment of the present disclosure. Electronic device 10 may include various internal and/or external components which contribute to the function of device 10. Those of ordinary skill in the art will appreciate that the various functional blocks shown in FIG. 1 may comprise hardware elements (including circuitry), software elements (including computer code stored on a computer-readable medium) or a combination of both hardware and software elements. Further, it should be noted that FIG. 1 is merely one example of a particular implementation and is intended to illustrate the types of components that may be present in electronic device 10. For example, in the presently illustrated embodiment, these components may include I/O ports 12, one or more displays 14, input structures 16, processor(s) 18, memory 20, non-volatile storage 22, expansion card(s) 24, networking device 26, and power source 28, and one or more graphics processing units (GPUs) 30.

With regard to each of the illustrated components, I/O ports 12 may include ports configured to connect to a variety of external devices, such as a power source, headset or headphones, or other electronic devices (such as handheld devices and/or computers, printers, projectors, external displays, modems, docking stations, and so forth). I/O ports 12 may support any interface type, such as a universal serial bus (USB) port, a serial connection port, an IEEE-1394 (FireWire) port, an Ethernet or modem port, and/or an AC/DC power connection port. I/O ports 12 may also include one or more types of display interface ports providing for a connection to an external display device, such as a monitor, based upon a particular display standard. By way of example only, such display interface ports may support display standards including Video Graphics Array (VGA), Digital Visual Interface (DVI), DisplayPort or mini-DisplayPort, High Definition Multimedia Interface (HDMI), or Gigabit Video Interface (GVIF). In some embodiments, one or more of display interface I/O ports 12 may include High-Bandwidth Digital Content Protection (HDCP) features. As will be understood by those skilled in the art, HDCP may provide digital copy protection for digital content transmitted to a display device.

Display device(s) 14 may be used to display various images generated by device 10. In one embodiment, display 12 may be an external monitor, such as a liquid crystal display (LCD), an Organic Light Emitting Diode (OLED) display, or any suitable display. Display(s) 14 may be based on one or more of the display standards mentioned above (e.g., VGA, DVI, HDMI, DisplayPort, etc.). Additionally, in certain embodiments of electronic device 10, display 14 may be provided in conjunction with a touch-sensitive element, such as a touchscreen, that may be used as part of a user interface for device 10. As mentioned above, embodiments of the present disclosure may provide for a display simulator application for simulating virtual displays. As will be discussed below, while the simulated displays are “virtual” (e.g., not physical devices), they may nevertheless appear to electronic device 10 as physical displays 14 and, thus, electronic device 10 may display generated images on both physically connected displays as well as virtual displays.

Input structures 16 may include the various devices, circuitry, and pathways by which user input or feedback is provided to one or more processor(s) 18. Such input structures 16 may be configured to control a function of device 10, applications running on device 10, and/or any interfaces or devices connected to or used by electronic device 10. For example, input structures 16 may allow a user to navigate a displayed user interface or application interface. Examples of input structures 16 may include buttons, switches, control pads, knobs, scroll wheels, keyboards, mice, touchpads, and so forth. User interaction with input structures 16, such as to interact with a user or application interface displayed on display 14, may generate electrical signals indicative of the user input. These input signals may be routed via suitable pathways, such as an input hub or data bus, to processor(s) 18 for further processing.

In addition to processing various input signals received via input structure(s) 16, processor(s) 18 may control the general operation of device 10. For instance, processor(s) 18 may provide the processing capability to execute an operating system, programs, user and application interfaces, and any other functions of electronic device 10. Processor(s) 18 may include one or more microprocessors, such as one or more “general-purpose” microprocessors, one or more special-purpose microprocessors and/or application-specific microprocessors (ASICs), or some combination of such processing components. As will be appreciated, processor(s) 18 may be coupled to one or more data buses for transferring data and instructions between various components of device 10.

The instructions or data to be processed by processor(s) 18 may be stored in a computer-readable medium, such as memory 20. Memory 20 may be provided as a volatile memory, such as random access memory (RAM) or as a non-volatile memory, such as read-only memory (ROM), or as a combination of one or more RAM and ROM devices. Memory 20 may store a variety of information and may be used for various purposes. For example, memory 20 may store firmware for electronic device 10, such as a basic input/output system (BIOS), an operating system, various programs, applications, or any other routines that may be executed on electronic device 10. In addition, memory 20 may be used for buffering or caching during operation of electronic device 10.

Device 10 may further include non-volatile storage 22 for persistent storage of data and/or instructions. Non-volatile storage 22 may include flash memory, a hard drive, or any other optical, magnetic, and/or solid-state storage media, or some combination thereof. Non-volatile storage 22 may be used to store data files such as firmware, data files, software programs and applications, wireless connection information, personal information, user preferences, and any other suitable data.

The embodiment illustrated in FIG. 1 may also include one or more card or expansion slots. The card slots may be configured to receive one or more expansion cards 24 that may be used to add functionality, such as additional memory, I/O functionality, or networking capability, to the electronic device 10. Expansion card 24 may connect to device 10 through any type of suitable connector, and may be accessed internally or external with respect to a housing of electronic device 10. For example, in one embodiment, expansion card 24 may be flash memory card, such as a SecureDigital (SD) card, mini- or microSD, CompactFlash card, Multimedia card (MMC), or the like. Additionally, expansion card 24 may be a video graphics card that may include a graphics processing unit (GPU), as well as video memory which may be used to provide frame buffers, texture maps, array storage, or other suitable information.

The components depicted in FIG. 1 also include network device 26, such as a network controller or a network interface card (NIC). In one embodiment, network device 26 may be a wireless NIC providing wireless connectivity over any 802.11 standard or any other suitable wireless networking standard. Network device 26 may allow electronic device 10 to communicate over a network, such as a Local Area Network (LAN), Wide Area Network (WAN), such as an Enhanced Data Rates for GSM Evolution (EDGE) network for a 3G data network (e.g., based on the IMT-2000 standard), or the Internet. Additionally, network device 26 may provide for connectivity to a personal area network, such as a Bluetooth® network. As will be understood, device 10 may use network device 26 to connect to and send or receive data with any device on a common network, such as portable electronic devices, personal computers, printers, and so forth. Alternatively, in some embodiments, electronic device 10 may not include network device 26. In such an embodiment, a NIC may be added as expansion card 24 to provide networking capability.

Electronic device 10 also includes power source 28. In one embodiment, power source 28 may be provided as one or more batteries, such as a lithium-ion polymer battery. The battery may be user-removable or may be secured within the housing of electronic device 10, and may be rechargeable. Additionally, power source 28 may include AC power, such as provided by an electrical outlet, and electronic device 10 may be connected to power source 28 via a power adapter, which may also be used to recharge one or more batteries if present.

Device 10 may additionally include one or more Graphics Processing Units (GPUs) 30. GPU 30 may be a separate processing unit (e.g., with respect to processor(s) 18) and may drive display 14 by rendering graphics such as images, video, games, or other media to be displayed on display 14. In some embodiments, GPU 30 may be an integrated GPU (also referred to as an on-board GPU) such that GPU 30 is integrated with a chipset of electronic device 10. In other embodiments, GPU 30 may be a dedicated processing unit that is not integrated with a chipset of electronic device 10 and may have dedicated resources, such as video memory. By way of example, where expansion card 24 includes a video graphics card, GPU 30 may be provided thereon.

As will be appreciated, GPU 30 may include 2D and 3D processing capabilities and may include video memory (such as shared memory or GDDRx memory). Such video memory may be used as frame buffers, texture maps, array storage, or other suitable information. Additionally, GPU 30 may include any number of rendering pipelines and may be programmable for specific features for 3D processing, e.g., programmable shaders. For example, each GPU 30 may be capable of executing instructions encoded using a 3D programming API, such as OpenGL, DirectX, or any other suitable API. In some embodiments, GPU 30 may be a GPU manufactured by Nvidia Corporation of Santa Clara, Calif., Advanced Micro Devices, Inc. of Sunnyvale, Calif., and/or Intel Corporation of Santa Clara, Calif. Further, GPU 30 may include any number of inputs and outputs and may drive an external display in addition to or instead of display 14.

In one embodiment, GPU 30 may include multiple GPUs, including a “low-power” GPU and a “high-power” GPU. For instance, a low-power GPU may have less processing power (e.g., lower clock speed, lower throughput, fewer pipelines, less video memory, etc.) and may consume less power than a high-power GPU which, in comparison, may have more processing capabilities and consumer more power than a low-power GPU. N such an embodiment, the low-power GPU may be used to reduce power usage of electronic device 10 when graphics processing demand is low. In contrast, the high-power GPU may be used when running applications where heavy or intense graphics processing is in demand and/or during conditions where power usage is not as great a concern (e.g., power is provided via an AC adaptor).

As discussed above, device 10 further includes display simulator application 32, which may be stored in non-volatile storage 22. As will be discussed further below, display simulator application 32 may provide for the simulation of virtual display devices, which may be recognized by electronic device 10 as a physical display 14. In one embodiment, display simulator application 32 may provide a user interface through which a user may input one or more parameters for simulating a display device. The simulated “virtual” display device may be recognized and appear to operating system 34 as being a physical display device (e.g., display device 14). Display simulator application 32 may further provide a mechanism by which the image output in a virtual frame buffer corresponding to the virtual display is viewable by a user, such as by providing a viewable graphical window on display 14.

Operating system 34 serves as an interface between a user and the illustrated hardware components of electronic device 10, and may function as a host for applications run on electronic device 10, including display simulator application 32. By way of example, operating system 34 may be a version the Mac OS® operating system, available from Apple Inc., of Cupertino, Calif., a version of the Windows® operating system, available from Microsoft Corporation of Redmond, Wash., a version of the OS/2® operating system, available from IBM Corporation of Armonk, N.Y., and so forth.

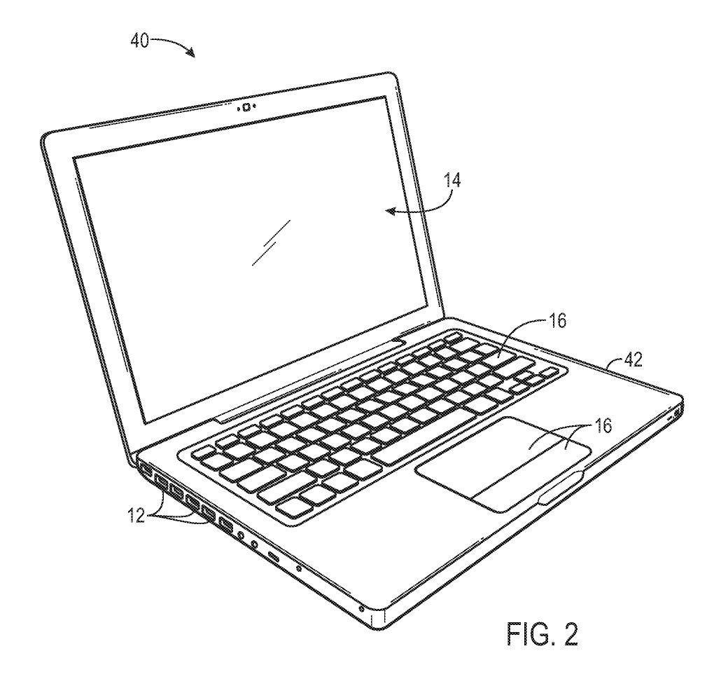

As shown in FIG. 2, electronic device 10 may take the form of a computer or other type of electronic device. Such computers may include computers that are generally portable (such as laptop, notebook, and tablet computers), as well as computers that are generally used in one place (such as conventional desktop computers, workstations and/or servers). In certain embodiments, electronic device 10 in the form of a computer may be a model of a MacBook®, MacBook® Pro, MacBook Air®, iMac®, Mac® mini, or Mac Pro® available from Apple Inc. By way of example, an electronic device 10 in the form of a laptop computer 40 is illustrated in FIG. 2 in accordance with one embodiment. The depicted computer 40 includes housing 42, display 14, input devices 16, and I/O ports 12.

In one embodiment, input devices 16 (such as a keyboard and/or touchpad) may be used to interact with computer 40, such as to start, control, or operate a graphical user interface (GUI) or applications running on computer 40. For example, a keyboard and/or touchpad may allow a user to navigate a user interface or application interface displayed on display 14. By way of example only, display 14 may be a LCD that interfaces with computer 40 using DisplayPort, DVI, VGA, or any other suitable standard.

As depicted, electronic device 10 in the form of computer 40 may also include various I/O ports 12 to allow connection of additional devices. For example, I/O ports 12 may include one or more display interface ports, such as an HDMI port, a DVI port, a VGA port, a DisplayPort or mini-DisplayPort interface, and so forth, suitable for connecting computer 40 to an external display device, such as another LCD monitor. In addition, computer 40 may include network connectivity, memory, and storage capabilities, as described with respect to FIG. 1. As a result, computer 40 may store and execute a GUI and other applications, including display simulator application 32.

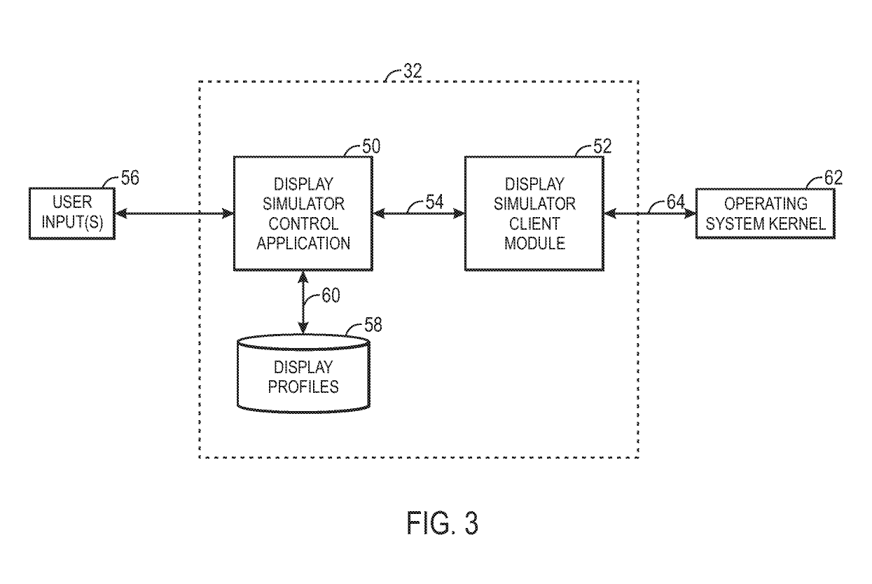

Referring now to FIG. 3, a simplified block diagram of an embodiment of display simulator application 32 is illustrated. Display simulator application 32 may include control application 50 configured to communicate with client module 52, as indicated by communication interface 54. Control application 50 generally provides a user interface by which a user may select and/or specify a particular display device to simulate. For instance, user input 56, which may be received by control application 50, may correspond to a user selection of a particular display profile selected from a plurality of display profiles 58, which may be stored in non-volatile storage 22. Additionally, control application 50 may allow a user to define custom display profiles, which may stored into the plurality of display profiles 58. Thus, as indicated by bi-directional interface 60, control application 50 may retrieve display profiles from display profile storage 58, or send data representing user-created display profiles to display profile storage 58. As will be discussed further below, a display profile may essentially define the characteristics of a display device that is to be simulated on electronic device 10. For instance, a display profile may specify a display standard (e.g., DisplayPort, VGA, DVI, HDMI, etc.), Extended Display Identification Data (EDID), and/or Monitor Command Control Set (MCCS), and may also specify supported interrupt events (e.g., hot-plug), HDCP support, and so forth.

In the context of physical display devices, EDID information typically includes timings, resolutions, pixel clocks and mapping data, manufacturer name and serial number, product type, filter type, and other parameters supported by a particular display device. In a physical display, EDID information is typically stored in a non-volatile memory device, such as a PROM or EEPROM. When the physical display (e.g., display 14) is connected to a display interface port on a device, such as I/O port 12 on electronic device 10, an interrupt may be relayed to an operating system running on electronic device 10 by way of a driver corresponding to display interface port 12 to which display 14 is connected. Operating system 34 may perform a query for EDID information. EDID information may be transmitted from display 14 to the corresponding driver using an I²C bus (e.g., in accordance with Display Data Channel (DDC) standards). Once the EDID information is retrieved, operating system 34 may access the supported display resolutions, timings, and other properties of display 14 and may either select a default setting or present the available settings to a user for selection.

Referring still to FIG. 3, display simulator application 32 may provide for a plurality of virtual I/O ports, particularly virtual display interface ports. Initially, each of the virtual display interface ports may be generic and do not correspond to any specific display standard (e.g., VGA, DVI, HDMI, DisplayPort, etc.). When a selected display profile is transmitted to client module 52 (e.g., by way of interface 54), the information in the selected display profile is provided to kernel 62 of operating system 34 (via interface 64). The set of information contained in the display profile may include any type of information defining one or more characteristics of a display device, such as information pertaining to a display interface type, hot plug information, display resolution information, display timing information, audio support information (e.g., audio support with HDMI interfaces), Display Data Channel (DDC) information, EDID information, MCCS information, or any other type of display characteristic information.

The selected display profile may be used to configure a generic virtual display port based upon the selection. For instance, if a selected display profile corresponds to a VGA-type display, a reference frame buffer driver, a virtual frame buffer driver, and the virtual display interface are configured to simulate a VGA port connected to a simulated VGA display device. Thus, from the view point of operating system 34, the simulated VGA port appears as one of I/O ports 12, and the simulated “virtual” VGA display device appears as a second external display 14.

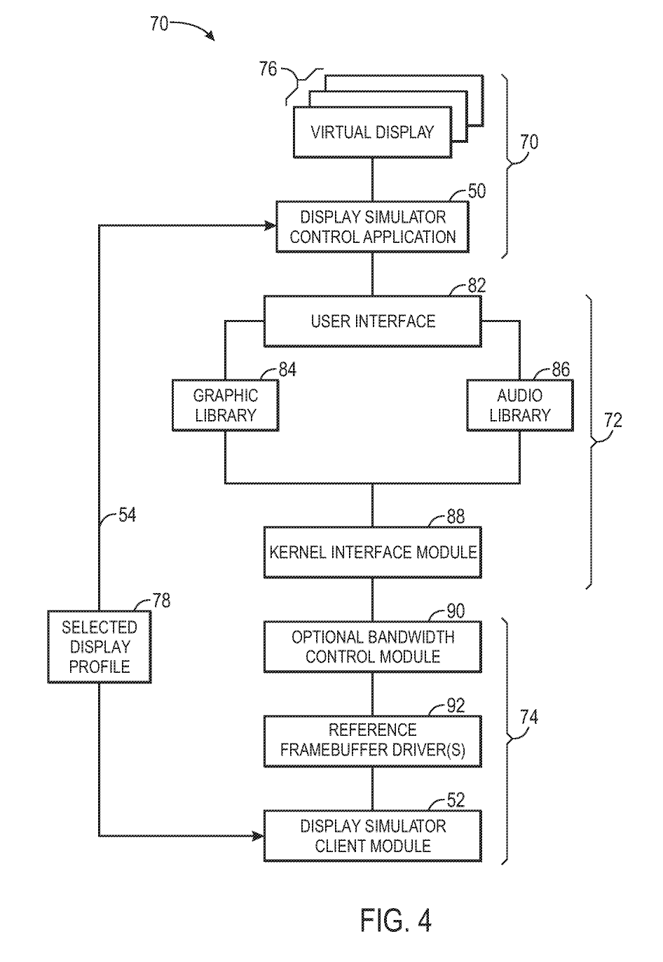

Referring now to FIG. 4, a system block diagram of software stack 70 that includes display simulator application 32 is illustrated, in accordance with one embodiment. Software stack 70 includes sections 70, 72, and 74. Section 70 may be an application layer that includes the control application portion 50 of display simulator application 32. By way of control application, image data stored in virtual frame buffers may be viewed in virtual display windows, represented here by reference number 76. Section 72 may be an API layer that includes user interface 82, graphics libraries 84 and audio libraries 86, and kernel interface module 88. Kernel interface module 88 may provide an interface between application layer 70 and graphics drivers, which may be part of system kernel 62. Section 74 may be part of kernel 62, and may include bandwidth control module 90, one or more reference frame buffer drivers 92, and display simulator client module 52.

As shown in the present embodiment, display simulator client module 52 may receive selected display profile 78 from display simulator control application 50 via communication interface 54. As mentioned above, reference frame buffer 92, which may include one or more virtual GPUs, virtual frame buffer drivers, and virtual frame buffers, may be configured using selected display profile 78, to provide a virtual display interface port and virtual display device corresponding to selected display profile 78. By way of example, if selected display profile 78 corresponds to a DVI display, the virtual display interface port is configured to perform the functions of a DVI interface port, and may appear to operating system 34 of device 10 as a physical I/O port 12 connected to a physical external DVI display although, as will be appreciated, the “external DVI display” is actually simulated by display simulator application 32 and exists only in software (e.g., in memory 20). In other words, display simulator application 32 creates a virtual copy of a physical device (e.g., display 14) in system memory (e.g., 20) that is recognized by operating system 34 as being a physical device.

As will be discussed further below, display simulator application 32 may be configured to provide for the simulation of any number of display devices on electronic device 10. However, as the number of display devices 14 increases, the available bandwidth for transmitting display data to each of the displays may be reduced. Accordingly, bandwidth control module 90 may control resolutions, refresh rates, and so forth, in order to ensure that each display device 14 is allocated sufficient bandwidth to render and display images without errors. By way of example, in one embodiment, a first display device connected directly to one I/O port 12 may include an internal display hub configured to connect to another display device (e.g., downstream from the first display device), and bandwidth control module 90 may be utilized to manage bandwidth allocation between the first display device and the other display device connected to the internal display hub.

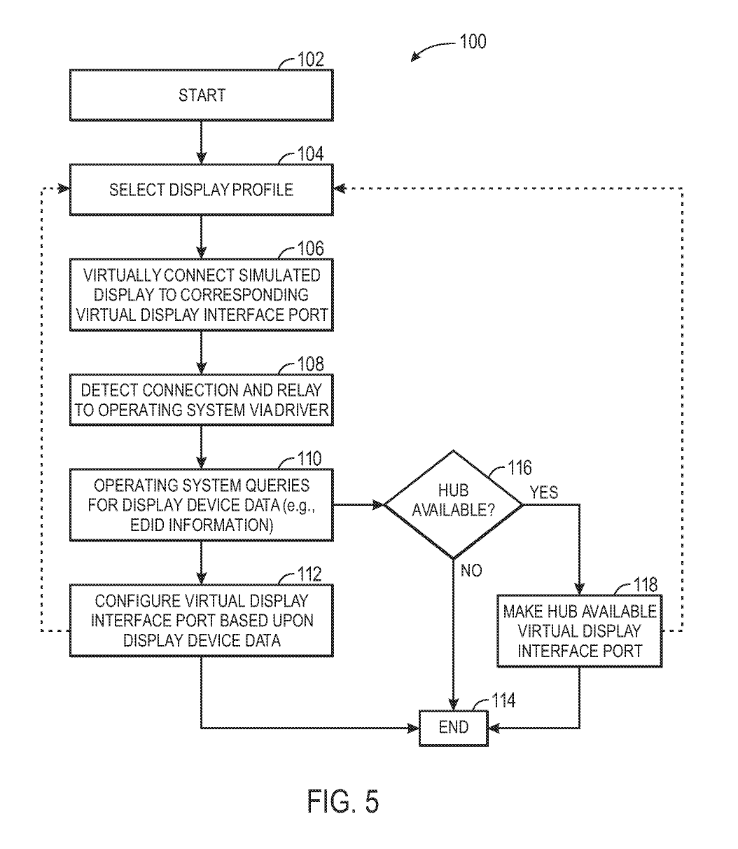

Referring now to FIG. 5, a flowchart depicting a method 100 for simulating a virtual display is illustrated and begins at step 102, in accordance with an embodiment of the present invention. At step 104, a display profile is selected. For instance, with reference to FIG. 4, the selected display profile may be display profile 78. As discussed above, the display profile may be selected from display profile storage 58, or may be created by a user using control application 50. Display profile 78 may include information defining a display device, such as a display standard (e.g., DisplayPort, VGA, DVI, HDMI, etc.), EDID information, MCCS information, supported interrupt events (e.g., hot-plug), HDCP support, and so forth. Next, at step 106, the simulated display (e.g., corresponding to display profile 78) is connected to a virtual display interface port. As discussed above, this step may include configuring a reference frame buffer (e.g., 92), which may include one or more virtual GPUs, virtual frame buffer drivers, and virtual frame buffers, in accordance with parameters from selected display profile 78.

At step 108, the connection of the virtual display to the virtual display interface port may be detected by operating system 34, such as by simulating an interrupt event. By way of example, the reference driver corresponding to the virtual display interface port may relay an interrupt, such as a hot-plug event, to operating system 34. Operating system 34, at step 110, may then perform a query for the display device data stored within selected display profile 78. For instance, the queried data may include EDID information, MCCS information, as well as any other suitable type of information that may define one or more characteristics of the simulated display device. Using the display information, the virtual display interface port may be configured to support the display type, which may correspond to a particular display interface standard (e.g., DisplayPort, DVI, VGA, etc), as indicated by step 112. Following step 112, method 100 may end at step 114, or may return to step 104, wherein a user may select additional display profiles for simulating additional virtual displays. As will be appreciated, the number of simulated displays may be at least partially limited by available bandwidth and/or the number of available virtual display interface ports provided by display simulator application 32.

As discussed above, some display standards may provide for the daisy-chaining of multiple displays on a single I/O port 12, wherein additional display devices 14 may be connected to a hub on or in a primary display device 14 (e.g., connected directly to I/O port 12). Returning to step 110, method 100 may additionally proceed to step 116 to determine if a display type specified by selected display profile 78 provides a display hub. If selected display profile 78 does not support a display type having additional display hubs, method 100 ends at 114. If selected display profile 78 does provide for display hubs, then the display hub may be recognized as an additional virtual port for connecting additional virtual displays with a first virtual display (e.g., corresponding to selected display profile 78), as shown at step 118. From step 118, method 100 may either conclude at step 114, or may return to step 104, wherein a user may select additional display profiles for simulating additional virtual displays.

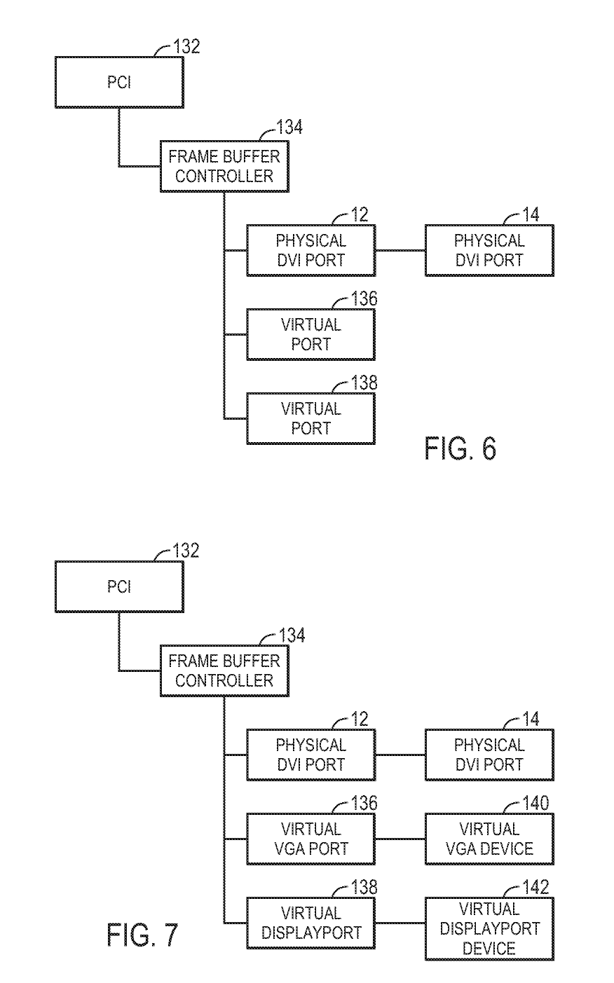

To better illustrate the above-described techniques, FIGS. 6-8 provide block diagram representations showing the simulation of virtual displays on device 10, in accordance with one embodiment. Referring first to FIG. 6, system bus 132, which may be provided on electronic device 10, is shown. In the illustrated embodiment, system bus 132 is a Peripheral Component Interconnect (PCI) bus. In other embodiments, system bus 132 may be PCI-X, PCI Express, Accelerated Graphics Port (AGP), a VESA bus, or any other suitable type of bus. As will be appreciated, various different bus architectures may provide for different data transmission speeds and/or bandwidth.

PCI bus 132 includes frame buffer controller 134. Frame buffer controller 134 may manage and/or track the status of available display interface ports on electronic device 10. For instance, frame buffer controller 134 may indicate the presence of a DVI display interface port (part of I/O ports 12), and that a DVI display device 14 is connected to the DVI port 12. Further, frame buffer controller 134 may indicate the presence of one or more virtual ports 136 and 138 which, as discussed above, may be provided by display simulator application 32. Though only two virtual ports are shown in the present embodiment, it should be appreciated that any number of virtual ports may be provided, subject to bandwidth and display hardware constraints (e.g., processing capabilities of GPU 30). As shown in FIG. 6, only a single physical DVI display device 14 is presently connected to DVI port 12. That is, FIG. 6 represents the state of bus 132 before any additional displays are simulated.

Continuing to FIG. 7, system bus 132 is now updated following the simulation of one or more display devices using display simulator application 32. In particular, the present example illustrates the simulation of a VGA display device on virtual port 136 and a DisplayPort display device on virtual port 138. For instance, updated frame buffer controller 132 indicates the presence of virtual VGA port 136 and virtual DisplayPort port 138. Virtual VGA port 136 is connected to virtual VGA display 140, and virtual DisplayPort port 138 is connected to virtual DisplayPort display 142. As will be appreciated, the simulation of each virtual display 140 (VGA) and 142 (DisplayPort) may be performed in accordance with method 100, as discussed above with reference to FIG. 5. Further, while the ports 136 and 138 are referred to as “virtual” ports in the present disclosure, it should be understood that this term is only meant to refer to the fact that ports 136 and 138 are emulated in software. However, from the view point of operating system 34, the virtual ports 136 and 138 appear as physical ports (i.e., one of I/O ports 12) each coupled to simulated displays 140 and 142 which, likewise, appear to operating system 34 as physical display devices 14.

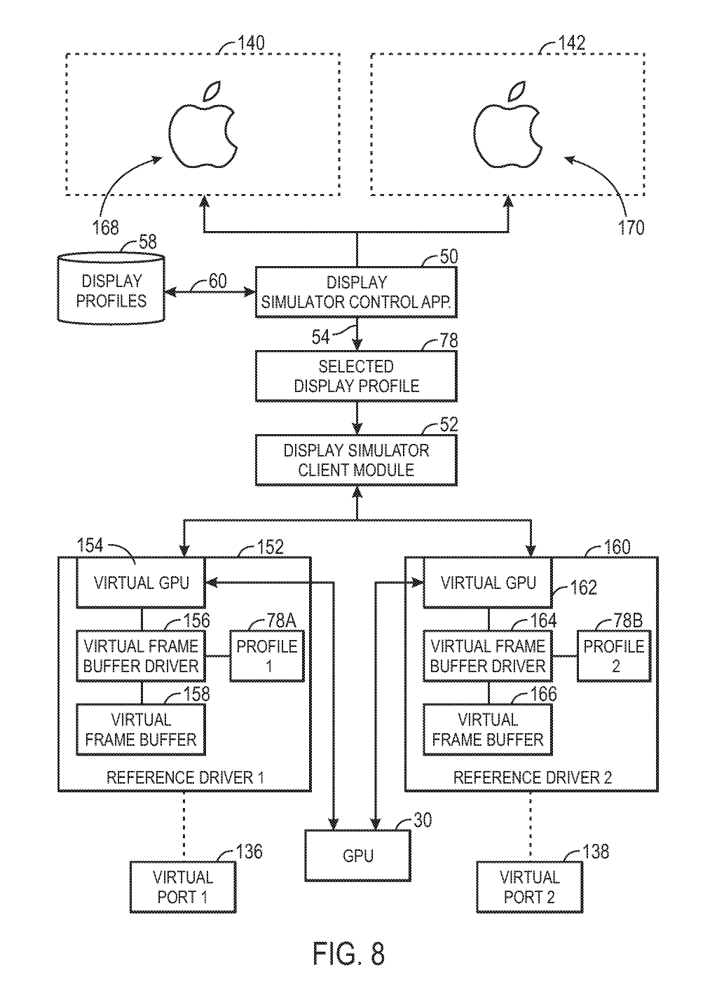

FIG. 8 provides a system diagram of display simulator application 32 including the virtual displays simulated in FIG. 7. As shown, control application 50 (of display simulator application 32) sends selected display profiles 78 to display simulator client module 52. For instance, a first selected display profile 78a may correspond to a VGA-type display. Thus, reference frame buffer driver 152, which corresponds to virtual display port 136 and includes virtual GPU 154, virtual frame buffer driver 156, and virtual frame buffer 158, may be suitably configured to provide for the simulation of VGA display device 140. It should be noted that from the view point of operating system 34, simulated VGA port 136 and simulated VGA display 140 appear as actual physical devices.

Additionally, a second selected display profile 78b may correspond to a DisplayPort display. Thus, reference frame buffer driver 160, which corresponds to virtual display port 138 and includes virtual GPU 162, virtual frame buffer driver 164, and virtual frame buffer 166, may be suitably configured to provide for the simulation of DisplayPort display device 142. Again, it should noted that from the view point of operating system 34, simulated DisplayPort port 138 and simulated DisplayPort display 142 appear as actual physical devices. In some embodiments, a selected display profile (e.g., 78a or 78b) may also include audio features. For instance, where a selected display profile corresponds to a display interface that provides for both the transmission of audio and video, such as DisplayPort or HDMI technologies, the selected display profile may define both display/video characteristics and audio characteristics.

Further, it should be understood that display simulator application 32 may allow a user to essentially simulate any type of display behavior. For instance, as mentioned above, a user may simulate hot-plug events, I²C communication events (e.g., to retrieve EDID data), as well as communication errors. Additionally, where HDCP features are simulated, digital copy protection may be applied to the simulated display (e.g., limiting audio quality, video resolution/bit-rate/frame-rate, etc.).

In one embodiment, each of virtual GPUs 154 and 162 may be a driver layer between a graphics framework (e.g., an OpenGL framework) and virtual frame buffer drivers 156 and 164, respectively. As shown, virtual GPUs 154 and 162 may interpret, route, and switch function calls from the graphics framework to GPU 30.

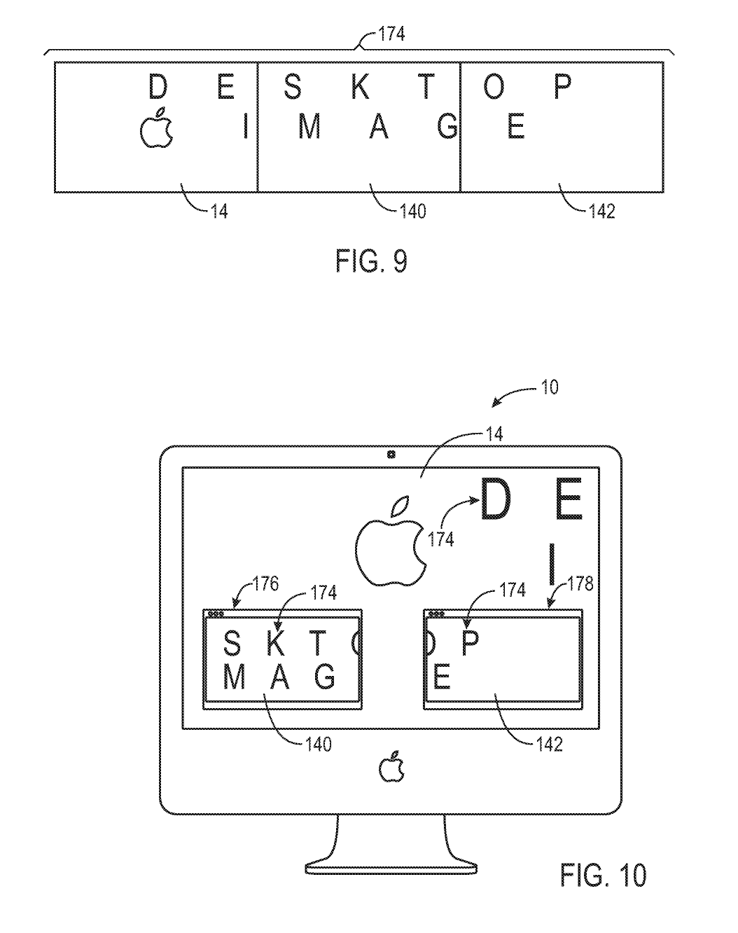

As discussed above, display devices simulated using display simulator application are viewed no differently by operating system 34 of device 10 compared to physical displays 14. In some embodiments, operating system 34 may include a graphical user interface, such as a virtual desktop. Where multiple display devices are present, including physical displays 14 and simulated displays (e.g., 140 and 142), the virtual desktop may be “stretched” or expanded across all of the displays. For instance, keeping the physical and simulated displays of FIGS. 6-8 in mind and referring to FIG. 9, a stretched desktop 174 may extend across physical DVI display device 14, virtual VGA display device 140, and virtual DisplayPort device 142. It should be understood that FIG. 9 depicts a scenario that assumes each display device 14, 140, and 142 is a physical display arranged side by side in the manner shown to provide the effect of an “extended” or “stretched” virtual desktop, wherein the display device 14 acts as a primary desktop, and virtual display devices 140 and 142 act as secondary desktops.

Where one or more virtual displays are present, control application 50 may provide a feature to output image data in a virtual frame buffer of the corresponding virtual display and onto physical display to enable a user to view the images being displayed by the virtual displays. For instance, as shown in FIG. 10, electronic device 10 may be a desktop computer system having DVI display device 14 in the form of an LCD display. As shown, control application 50 may provide for the display of windows 176 and 178 on display device 14. Window 176 may display image data from virtual frame buffer 156, which corresponds to virtual VGA display 140, and window 178 may display image data from virtual frame buffer 164, which corresponds to virtual DisplayPort display device 142. As can be appreciated, windows 176 and 178 may be resized and/or moved within display device 14. Additionally, in some embodiments, control application 50 may provide a user the ability to toggle the designation of the primary display. For instance, to test various aspects of the simulated displays, and thus the underlying software, a user may select virtual display 140 as a primary desktop, with displays 14 and 142 as secondary displays (e.g., wherein image 174 extends from display 140 onto displays 14 and 142).

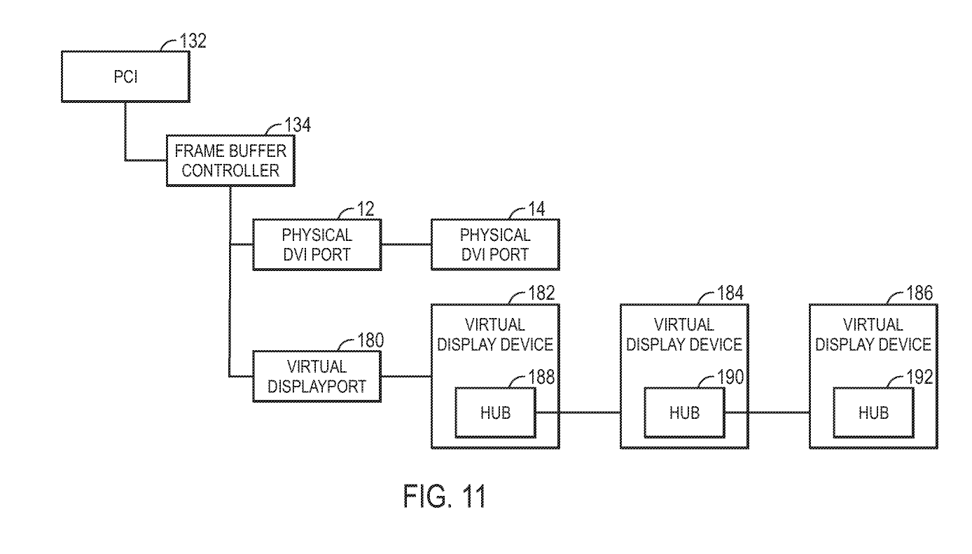

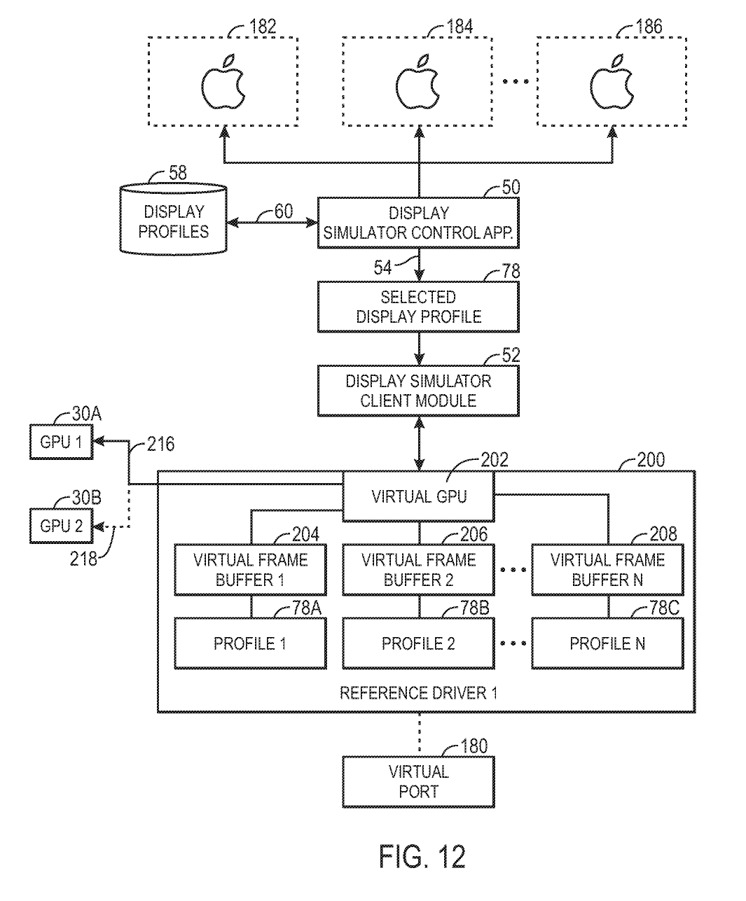

As discussed above, display simulator application 32 may further provide for the simulation of display devices that support the connection of multiple display devices in series to a common port (e.g., daisy-chaining). For instance, such a display standard is contemplated in the upcoming DisplayPort version 1.2 specification currently being developed by VESA and expected for adoption and/or release in the near future. FIGS. 11 and 12 illustrate the simulation of multiple display devices in a daisy-chained configuration using the display simulation techniques discussed herein. For simplicity, elements previously discussed with reference to FIGS. 6 and 7 are numbered with like reference numerals.

As shown in FIG. 11, frame buffer controller 134 of PCI bus 132 indicates the presence of DVI display interface port 12 having DVI display device 14 connected thereto. Frame buffer controller 134 also indicates the presence of virtual display port 180. In the present embodiment, virtual display port 180 may represent a type of display interface that supports daisy-chaining of multiple displays (e.g., DisplayPort version 1.2). For instance, virtual display port 180 may be connected to virtual display devices 182, 184, and 186. Each of virtual display devices 182, 184, and 186 includes virtual display hubs 188, 190, and 192, respectively.

Referring back to method 100 of FIG. 5, virtual display devices 182, 184, and 186 may be simulated sequentially. For instance, a user may select a display profile corresponding to virtual display device 182 that includes display hub 188. Thus, at steps 116 and 118 of method 100, display hub 188 may be specified as a virtual connection point, to which virtual display 184 may be subsequently connected. That is, display hub 188 may be recognized by display simulator application 32 as another virtual port configurable to be connected to another simulated display device. Similarly, virtual display device 184 includes display hub 190, which be further connected downstream to virtual display device 186. Thus, in the present simulation, virtual display devices 182, 184, and 186 are each connected to virtual port 180 in series, with virtual display device 182 being directly connected to port 180, virtual display device 184 being connected to port 180 through display device 182 (e.g., via hub 188), and virtual display device 186 being connected to port 180 through display devices 182 and 184 (e.g., via hubs 188 and 190, respectively). Again, it should be noted that from the view point of operating system 34, virtual port 180 appears as a physical port (i.e., an I/O port 12), and virtual display devices 180, 182, and 184 appear as physical display devices.

FIG. 12 provides a system diagram of display simulator application 32 that includes virtual displays 182, 184, and 186 simulated in FIG. 11. As shown, control application 50 (of display simulator application 32) sends selected display profiles 78 to display simulator client module 52. For instance, selected display profiles 78 may include first, second and third display profiles 78a, 78b, and 78c, respectively, each of which may correspond to a DisplayPort version 1.1 or 1.2 enabled device.

Based upon the simulation shown in FIG. 11, virtual display port 180 may be configured using reference frame buffer driver 200, which may include virtual frame buffers 204, 206, and 208, as shown in FIG. 12. Virtual frame buffer 204 may be configured in accordance with selected display profile 78a to provide for the simulation of virtual display device 182. Similarly, virtual frame buffer 206 may be configured in accordance with selected display profile 78b to provide for the simulation of virtual display device 184, and virtual frame buffer 208 may be configured in accordance with selected display profile 78c to provide for the simulation of virtual display device 186. Although only three virtual frame buffers (204, 206, and 208) are shown in the present embodiment, it should be understood that any number of virtual frame buffers (as denoted by frame buffer “N”) may be implemented by reference driver 200 for simulating any number of virtual display devices connected either directly or indirectly to virtual display port 180. Additionally, it should be noted that the reference driver 200 of the present embodiment may incorporate and provide the functions of the virtual frame buffer drivers (e.g., element 156 of FIG. 8). Further, due to the daisy-chained configuration, as shown in FIG. 11, each of virtual display devices 182, 184, and 186 may be driven by the single virtual GPU 202, which may interpret and route function calls to GPU 30.

As discussed above, in some embodiments, GPU 30 may include a high-power GPU, referred to here by reference number 30a, and a low-power GPU, referred to here by reference number 30b. In such embodiments, control application 50 may provide for the simulation of certain events, such as a power management event, hot-plug event, or other event that may initiate a switch of graphics processing resources. For example, if a graphics-intensive application (e.g., including 3D acceleration, texture mapping, anti-aliasing, and/or surface rendering, etc.) is being run on one or more of virtual display devices 182, 184, and 186, virtual GPU 202 may route function calls to high-power GPU 30a by way of interface 216. If less intensive graphics processing application is being run, virtual GPU 202 may route function calls to low-power GPU 30b. As will be appreciated, virtual GPU 202 provides an abstraction layer, such that transitions between high-power GPU 30a and low-power GPU 30b are seamless from both an operating system and user point of view.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

What is claimed is:

1. A method comprising:
selecting a display profile based upon a user input; and
simulating a display device on a computing system based upon the selected display profile.

2. The method of claim 1, wherein simulating the display device comprises:
virtually connecting the simulated display device to a virtual display interface port;
determining one or more display characteristics of the simulated display device, including at least a display interface type, based upon the selected display profile;
configuring the virtual display interface port based upon the display interface type; and
configuring a reference frame buffer driver based upon the one or more display characteristics.

3. The method of claim 2, wherein, in addition to the display interface type, the one or more display characteristics includes one or more of supported display resolutions, supported display timings, supported refresh rates, pixel mapping data, or some combination thereof.

4. The method of claim 2, wherein the display interface type comprises a DVI display interface, a VGA display interface, an HDMI display interface, a DisplayPort display interface, a mini-DisplayPort display interface, or a GVIF display interface, or some combination thereof.

5. The method of claim 2, wherein determining the one or more characteristics of the simulated display device comprises:
simulating a hot-plug event upon detecting a virtual connection between the simulated display device and the virtual display interface port; and
reading the one or more characteristics from a set of information defined by the selected display profile.

6. The method of claim 5, wherein the set of information at least partially comprises information defining the display interface type, hot plug information, display resolution information, display timing information, audio support information, Display Data Channel (DDC) information, at least a portion of an Extended Display Identification Data (EDID) data set, or at least a portion of a Monitor Command Control Set (MCCS) data set, or any combination thereof.

7. The method of claim 2, wherein configuring the reference frame buffer comprises configuring one or more of a virtual frame buffer driver and a virtual graphics processor based upon the one or more display characteristics.

8. The method of claim 2, wherein the determined display interface type comprises an interface type that supports serially connecting a plurality of display devices to a single display interface port, wherein the simulated display device comprises a simulated display hub configurable to virtually connect to additional simulated display devices, and wherein the simulated display hub is recognized as another virtual display interface port.

9. The method of claim 1, wherein the simulated display device is recognized as a physical display device by an operating system running on the computing system.

10. A system comprising:
an electronic device comprising:
a storage device storing instructions defining a display simulator application, an operating system, and a plurality of selectable display profiles;
a processor configured to execute the instructions defining the display simulator application; and
at least one graphics processor;
wherein the display simulator application is configured to simulate a display device on the electronic device based upon a display profile selected from one of the plurality of selectable display profiles.

11. The system of claim 10, wherein the display simulator application comprises:
a control application configured to receive inputs from a user of the electronic device, wherein the selected display profile is selected based upon the received inputs; and
a client module configured to receive the selected display profile, to communicate the selected display profile to a kernel of the operating system, to simulate a display device corresponding to the selected display profile, and to virtually connect the simulated display device to a virtual display interface port.

12. The system of claim 11, wherein, if the received inputs do not correspond to one of the plurality of selectable display profiles, the control application is configured to create a new display profile based upon the received inputs and to store the new display profile in the storage device.

13. The system of claim 11, wherein simulating the display device comprises configuring a reference frame buffer based upon one or more characteristics of the simulated display device, the one or more characteristics being determined based at least partially upon the selected display profile.

14. The system of claim 13, wherein configuring the reference frame buffer driver comprises configuring a virtual frame buffer driver and a virtual graphics processor based upon the one or more determined characteristics.

15. The system of claim 14, wherein the virtual graphics processor is configurable to route function calls to at least one graphics processor.

16 The system of claim 15, wherein the at least one graphics processor comprises a first graphics processor and a second graphics processor, and wherein the control module is configured to control the virtual graphics processor to switch the routing of function calls between the first and second graphics processors.

17. The system of claim 16, wherein the first graphics processor is a high-power graphics processor and the second graphics power is a lower-power graphics processor, and wherein the switching the routing of function calls between the high-power and low-power graphics processors is based at least partially on graphics processing demands.

18. The system of claim 16, wherein the virtual graphics processor provides an abstraction layer, such that the switching between the first graphics processor and the second graphics processor is masked from a point of view of the operating system.

19. The system of claim 11, wherein the electronic device comprises a display device, and wherein the control application is configured to display a graphical window on the display device, the graphical window being configured to output image data from the virtual frame buffer corresponding to the simulated display device.

20. A method comprising:
selecting a first display profile, the first display profile defining a first display interface type;
virtually connecting a first simulated display device to a first virtual display interface port on a computing system based upon the first display profile; and
configuring the first virtual display interface port to function as the first display interface type.

21. The method of claim 20, comprising:
selecting a second display profile, the second display profile defining a second display interface type;
virtually connecting a second simulated display device to a second virtual display interface port on a computing system based upon the second display profile; and
configuring the second virtual display interface port to function as the second display interface type.

22. The method of claim 20, wherein the first simulated display device comprises a simulated display hub, and wherein the first display interface type is configured to support a serial connection of additional display devices.

23. The method of claim 22, comprising:
selecting a second display profile, the second display profile defining a second display interface type configurable to connect to the simulated display hub of the first simulated display device; and
virtually connecting a second simulated display device to the simulated display hub of the first simulated display device based upon the second display profile.

24. The method of claim 23, wherein the virtual display interface port is configured to communicate with a reference frame buffer on a computing system, wherein the reference frame buffer comprises a virtual graphics processor configured to drive each of the first and second simulated display devices.

25. The method of claim 23, comprising:
selecting a third display profile, the third display profile defining a third display interface type configurable to connect to a simulated display hub of the second simulated display device; and
virtually connecting a third simulated display device to the simulated display hub of the second simulated display device based upon the third display profile.

26. One or more tangible computer-readable storage media having instructions encoded thereon for execution by a processor, the instructions comprising:
code to receive a user input via a control application;
code to select, based on the user input, a display profile from a plurality of stored display profiles;
code to determine one or more characteristics of a display device defined by the selected display profile; and
code to simulate the display device on a computing system.

27. The one or more tangible computer-readable storage media of claim 26, wherein the code for determining one or more characteristics of the simulated display device comprises:
code to detect a virtual connection of the simulated display device to a virtual display interface port;
code to relay the detection of the virtual connection to an operating system of the computing system; and
code to query the simulated display device for the one or more characteristics.

28. The one or more tangible computer-readable storage media of claim 27, wherein the code to query the simulated display device comprises code to simulate the transmission of display identification information from the simulated display device to the computing system.

29. The one or more tangible computer-readable storage media of claim 27, wherein the code for simulating the display device on the computing system comprises code to configure a reference frame buffer driver in communication with the virtual display interface port, wherein the code to configure the reference frame buffer driver comprises code to configure a virtual graphics processor and a virtual frame buffer driver based upon the selected display profile.

30. The one or more tangible computer-readable storage media of claim 29, the code to configure the reference frame buffer driver comprises code to route function calls from the virtual graphics processor to at least one graphics processor of the computing system.

31. The one or more tangible computer-readable storage media of claim 30, wherein the code to route function calls from the virtual graphics processor to the at least one graphics processor comprises code to switch the routing of function calls between first and second graphics processors.
